(19) United States
(12) Patent Application Publication
(10) Pub. No.: US 2008/0103348 A1
(43) Pub. Date: May 1, 2008

(54) Processes for treatment of solid wastes containing heavy metals

(75) Inventor: Gregory S. Tunstall, Friendswood, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: Entact Services, LLC, Grapevine, TX (US)

(21) Appl. No.: 11/589,632

(22) Filed: Oct. 30, 2006

(51) Int. Cl. A62D 3/38

(52) U.S. Cl. 588/320

(57) ABSTRACT

Processes for treating hazardous wastes, such as impacted soils containing hexavalent chromium, to simultaneously both reduce Cr(VI) to Cr(III) and control leaching of chromium in soil or disposed waste. The processes includes a one-step reagent addition that results in treatment of the impacted materials in a single pass. The processes generally may include mixing the solid waste material containing hexavalent chromium to ensure a homogeneous mixture followed by treating the impacted material with a suitable treatment additive including sodium/calcium polysulfide. The processes result in a reduction of total concentration and leachable levels of chromium in the impacted material.

### BACKGROUND OF THE INVENTION

This invention relates to the treatment of contaminated materials, including soils and solids, and in particular to the physical and chemical treatment of waste or solids containing high levels of heavy metals, including chromium. More specifically, this invention relates to in-situ processes for reducing hexavalent chromium in impacted soils while at the same time decreasing the permeability of the solid waste to control leaching of chromium.

Hexavalent chromium is a known human carcinogen and has been the subject of extensive research. In the form of chromate, hexavalent chromium is related in structure to sulfate and phosphate and is able to enter human cells via the normal transport anion transport mechanisms similar to the way sulfate and phosphate would enter. Although it is believed that hexavalent chromium does not harm the human DNA, during the cellular reduction to trivalent chromium various intermediates are formed that are responsible for the DNA strand breakage which eventually leads to the development of carcinogenic symptoms. The main routes of exposure are the lungs, gastrointestinal tract and skin, with the gastrointestinal tract being the major pathway for exposure (food and water).

Chromium ore processing residue (COPR), a by-product generated during the processing of chromium ore, is a source of hexavalent chromium. Millions of tons of waste COPR were produced in the United States, and was in turn sold or given away as backfill for a multitude of diverse construction sites and purposes. As a result, various soils and waste water across the United States have been contaminated with hexavalent chromium. Its safe removal and disposal remains the focus of environmental cleanup efforts today.

Various methods have been developed in the art for dealing with hexavalent chromium in both waste water and residual sludges. Highly alkaline COPR, for example, containing a pH of greater than 11, has an inherent probability to leach hexavalent chromium into the local ground and surface waters. One accepted method of treatment is to first reduce the dissolved chromium to the trivalent state, followed by precipitation and flocculent generation and ultimate phase separation by traditional mechanical means. However, this process is not as efficient for treating residual sludges or solid wastes. Most soil treatment technologies used to convert hexavalent chromium to trivalent chromium in soils are very pH dependent. Traditional pH adjustments are conducted first via acid injection, to adjust the soil pH to a target range of less than 3.5. This step is followed by the addition of ferric salts or sulfides which create an oxidation/reduction reaction with the hexavalent chromium, converting it into trivalent chromium in the process. However, in highly alkaline soils the initial acid adjustment can become highly reactive and create expansive reactions. This is particularly true in the case of COPR-impacted soils which contain high concentrations of calcium.

Another long-recognized problem in the industry is the disposal of solid industrial wastes. Excavation of the subject wastes and either stockpiling the waste on-site, or transporting the waste to an alternative site, increases the risk to both the public and workers by exposing these toxic substances to the open environment. In addition, such treatments are extremely costly. But more importantly, when these stockpiles (either on-site or off-site) are wetted by rain, the soluble hexavalent chromium may leach into ground water, and/or contaminate other soils.

As such, there is a need in the art for an improved process for chemically converting the more toxic and highly soluble hexavalent chromium to the less toxic, less soluble trivalent chromium, but at the same time reducing undesirable reactions and by-products. In addition, there is a need in the art for development of a process that is able to be conducted in-situ instead of the traditional method of ex-situ excavation and treatment. There is also a need to be able to perform both site stabilization and waste treatment simultaneously as opposed to traditional methods that require two or more distinct phases of processing, thus reducing the overall costs of treatment of a hazardous waste site.

### SUMMARY OF THE INVENTION

The present invention provides an improved process and, more particularly, an in-situ process for treating hazardous wastes, such as impacted soils containing hexavalent chromium, to simultaneously both reduce Cr(VI) to Cr(III) and control leaching of chromium in soil or disposed waste. Accordingly, the process of the present invention includes a one-step reagent addition that results in treatment of the impacted soil in a single pass. The process generally may include mixing the solid waste material containing hexavalent chromium to ensure a homogeneous mixture. This step is followed by treating the impacted soil or solid waste with a suitable treatment additive, which in one embodiment is sodium/calcium polysulfide. Where chromium is present, the soluble toxic hexavalent chromium is reduced to the insoluble less toxic trivalent form. The treatment additive also serves to reduce the total concentration and leachable levels of chromium in the soil or solid waste.

In accordance with the present invention, the process may be conducted in-situ, and in a single step, such that the untreated waste mixture is contacted with the reagent in one phase of processing, thereby reducing cost, and eliminating an initial pre-treatment step of adjusting the pH in the soil and/or waste material to be treated. Optionally, the process includes contacting the treated mixture (or the untreated mixture if a slurry operation is used) with a hydraulic cement, such as for example, Portland cement.

In accordance with the present invention, no hexavalent chromium is detectable in the treated solid waste/soil mixture. In addition, the treated mixture generally contains in the range of from about 0.1 to about 1 mg of total chromium (SPLP) per liter of treated waste mixture. In one embodiment of the present invention, the treated waste mixture contains less than about 0.6 mg/L of total chromium (SPLP).

The addition rate in which the additive and/or hydraulic cement is contacted with the chromium-containing mixture is generally in the range of from about 15% to about 20% by weight, based on the weight of the un-treated mixture.

These and other embodiments and features of the invention, and the advantages thereof, will become readily apparent from the following detailed description of the invention, taken in conjunction with the drawings in which:

### BRIEF DESCRIPTION OF THE DRAWINGS

FIG. 1 is graph showing the concentrations of hexavalent chromium (Cr(VI)), and total chromium as determined by a Synthetic Precipitate Leachate Procedure (SPLP), in a highly concentrated field sample at various addition rates of FERROUS SULFATE (FeSO₄) reagent, added as a solid.

FIG. 2 is a graph showing the concentrations of hexavalent chromium (Cr(VI)), and total chromium (as determined by SPLP), in a highly concentrated field sample at various addition rates of FERROUS SULFATE (FeSO₄) reagent, added in solution.

FIG. 3 is a graph showing the concentrations of hexavalent chromium (Cr(VI)), and total chromium (as determined by SPLP), in a moderately contaminated field sample at various addition rates of FERROUS SULFATE (FeSO₄) reagent, added as a solid.

FIG. 4 is a graph showing the concentrations of hexavalent chromium (Cr(VI)), and total chromium (as determined by SPLP), in a moderately contaminated field sample at various addition rates of FERROUS SULFATE (FeSO₄) reagent, added in solution.

FIG. 5 is a graph showing the concentrations of hexavalent chromium (Cr(VI)), and total chromium (as determined by SPLP), in a highly contaminated field sample at various addition rates of SODIUM METABISULFITE (Na₂S₂O₅, Sodium PyroSulfite) added as a solid.

FIG. 6 is a graph showing the concentrations of hexavalent chromium (Cr(VI)), and total chromium (as determined by SPLP), in a highly contaminated field sample at various addition rates of SODIUM META BISULFITE (Na₂S₂O₅, Sodium PyroSulfite) reagent, added in solution.

FIG. 7 is a graph showing the concentrations of hexavalent chromium (Cr(VI)), and total chromium (as determined by SPLP), in a moderately contaminated field sample at various addition rates of SODIUM METABISULFITE (Na₂S₂O₅, Sodium PyroSulfite) reagent, added as a solid.

FIG. 8 is a graph showing the concentrations of hexavalent chromium (Cr(VI)), and total chromium (as determined by SPLP), in a moderately contaminated field sample at various addition rates of SODIUM METABISULFITE (Na₂S₂O₅, Sodium PyroSulfite) reagent, added in solution.

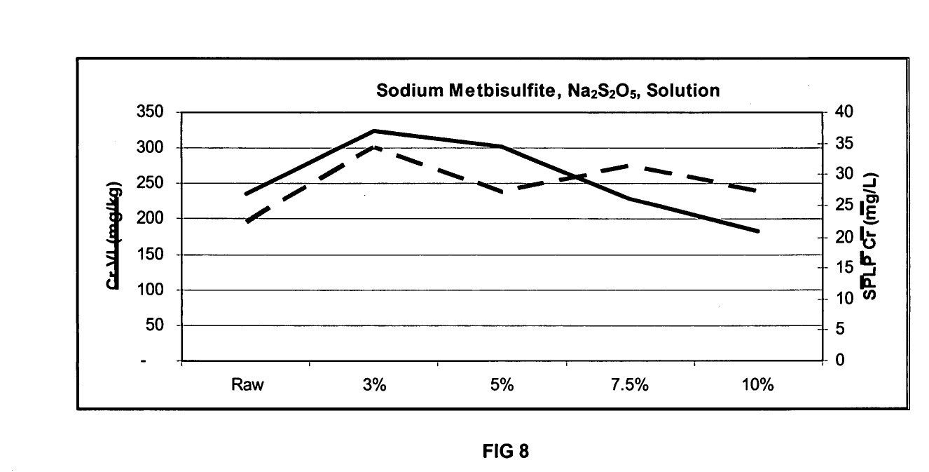

FIG. 9 is a graph showing the concentrations of hexavalent chromium (Cr(VI)), and total chromium (as determined by SPLP), in a highly contaminated field sample after various addition rates of SODIUM HYDROSULFITE (Na₂S₂O₄) reagent, added as a solid.

FIG. 10 is a graph showing the concentrations of hexavalent chromium (Cr(VI)), and total chromium (as determined by SPLP), in a highly contaminated field sample after various addition rates of SODIUM HYDROSULFITE (Na₂S₂O₄) reagent, added in solution.

FIG. 11 is a graph showing the concentrations of hexavalent chromium (Cr(VI)), and total chromium (as determined by SPLP), in a moderately contaminated field sample after various addition rates of SODIUM HYDROSULFITE (Na₂S₂O₄) reagent, added as a solid.

FIG. 12 is a graph showing the concentrations of hexavalent chromium (Cr(VI)), and total chromium (as determined by SPLP), in a moderately contaminated field sample after various addition rates of SODIUM HYDROSULFITE (Na₂S₂O₄) reagent, added in solution.

FIG. 13 is a graph showing the concentrations of hexavalent chromium (Cr(VI)), and total chromium (as determined by SPLP), in a highly contaminated field sample after various addition rates of SODIUM/CALCIUM POLYSULFIDE (Na/CaSₓ) reagent, added in solution.

FIG. 14 is a graph showing the concentrations of hexavalent chromium (Cr(VI)), and total chromium (as determined by SPLP), in a moderately contaminated field sample at various addition rates of CALCIUM POLYSULFIDE (CaSₓ, Aqua-Clear) reagent, added in solution.

FIG. 15 is a graph showing the concentrations of hexavalent chromium (Cr(VI)), and total chromium (as determined by SPLP), in a highly contaminated field sample at various addition rates of SODIUM/CALCIUM POLYSULFIDE (Na/CaSₓ) reagent, added in solution.

FIG. 16 is a graph showing the concentrations of hexavalent chromium (Cr(VI)), and total chromium (as determined by SPLP), in a moderately contaminated field sample at various addition rates of CALCIUM POLYSULFIDE (CaSₓ, Aqua-Clear) reagent, added in solution.

FIG. 17 is a graph showing the concentrations of hexavalent chromium (Cr(VI)), and total chromium (as determined by SPLP), in a highly contaminated field sample at various addition rates of SODIUM/CALCIUM POLYSULFIDE (Na/CaSₓ), added in solution.

FIG. 18 is a graph showing the concentrations of hexavalent chromium (Cr(VI)), and total chromium (as determined by SPLP), in a highly contaminated field sample at various addition rates of SODIUM/CALCIUM POLYSULFIDE (Na/CaSₓ), added in solution, with Portland Cement Type II, added in solution.

FIG. 19 is a flow diagram showing a scaled up application employing processes in accordance with the present invention.

FIG. 20 is a flow diagram showing the analytical methods used to determine total chromium, hexavalent chromium (Cr(VI), total SPLP chromium, and pH for samples identified in Example I.

### DETAILED DESCRIPTION OF THE PREFERRED EMBODIMENTS

Generally, the processes of the present invention may be used to treat of waste material containing heavy metals, including chromium, and may be used in the treatment of soils, solid wastes, and/or waste water. While the description herein specifically refers to the impact on chromium, it is understood that levels of other heavy metals present in the waste materials (such as for example, lead and arsenic) may be affected by the processes described herein.

Treatment additives useful in the present invention may be used individually or in combination and include, but are not limited to, ferrous sulfate, sodium metabisulfite, sodium hydrosulfide, sodium polysulfide, calcium polysulfide, sodium/calcium polysulfide, and the like and combinations thereof. These additives contain anions that precipitate the heavy metals into the soil or waste. Generally treatment additives may be employed in either their solid or liquid states, it being understood that some reagents only exist in the solid and/or liquid state. In selecting an appropriate additive, it is necessary to consider a variety of factors, including, site characteristics, and the feasibility of in-situ or ex-situ treatment. In addition, the type/amount of reagent employed may generally depend on the desired impact on the waste material, or in other words, a suitable reagent that will meet a specific regulatory criteria.

In certain embodiments, the additive may be used alone or in combination with a hydraulic cement, such as for example, Portland Cement. Use of the additive alone may prove adequate to meet the desired chemical and physical criteria. However, if the physical criteria, e.g., permeability, cannot be met with use of the additive alone, then a hydraulic cement, such as for example, a Portland Cement, can be added to provide the cementatious matrix which will decrease permeability.

A variety of hydraulic cements may be utilized in accordance with the present invention, including, but not limited to, those comprising calcium, aluminum, silicon, oxygen, iron, and/or sulfur, which set and harden by reaction with water. Suitable hydraulic cements include, but are not limited to, Portland cements, pozzolana cements, gypsum cements, high alumina content cements, slag cements, silica cements, and combinations thereof. In certain embodiments, the hydraulic cement may comprise a Portland cement. Different types of Portland cement are manufactured to meet various physical and chemical requirements. For example, the American Society for Testing and Materials (ASTM) Specification C-150 provides for eight types of Portland cement. Type I Portland cement is a normal, general-purpose cement suitable for all uses. It is used in general construction projects such as buildings, bridges, floors, pavements, and other precast concrete products. Type II Portland cement generally will generate less heat at a slower rate and has a moderate resistance to sulfate attack. Type V Portland cement, for example, is generally used only in concrete structures that will be exposed to severe sulfate action, principally where concrete is exposed to soil and groundwater with a high sulfate content.

Other components may be used in addition to, or in place of, the hydraulic cement, in accordance with the present invention. Such components may include, but are not limited to, and as an example, fly ash, slag cement, shale, metakaolin, micro-fine cement, and the like.

The current Universal Treatment Standard (UTS) for chromium in impacted soils is 0.6 mg/L as measured by the Synthetic Precipitate Leachate Procedure (SPLP). The SPLP test shows how metals might move from the soil to the groundwater by utilizing a synthetic permeant intended to reproduce the theoretical worse case leaching results from acid rain events. Procedures for the SPLP are described in Method 1312 of the U.S. Environmental Protection Agency's “Test Methods for Solid Waste, 846” which is incorporated herein by reference. As such, if treated soils leach total chromium at or below the Universal Treatment Standard of 0.6 mg/L, these soils are deemed suitable to be left in place.

The mixing of the contaminated disposed solid waste and soil with the treatment additive must be complete enough so that any small sample of the treated contaminated waste or soil (e.g. 100 grams) will meet the regulatory goal of 0.6 mg/L total chromium when tested by SPLP methods.

The term “non-leachable forms” as used herein means a form of chromium in the soil or disposed waste that, where subject to the leaching conditions of a SPLP test, will not leach chromium at above 0.6 mg/L.

Generally, additives useful in the present invention are present in the range of from about 1% to about 25%, based on the weight of the sample. In one embodiment of the present invention, the additive is present in the range of from about 17 to about 20 weight percent, based on the weight of the sample. In yet another embodiment of the present invention, the additive is present in an amount of about 20 weight percent, based on the weight of the sample.

If a hydraulic cement is used in combination with the additive, it is generally present in the range of from about 1% to about 20%, based on the weight of the sample. In one embodiment of the present invention, the waste sample is treated with Sodium/Calcium Polysulfide reagent in the range of from about 17.5% to 20% by weight, followed by about a 15% addition of Type II Portland cement.

Generally, materials treated in accordance with the processes of the present invention contain reduced levels of hexavalent chromium as compared to levels of hexavalent chromium in the un-treated mixture. In one embodiment of the present invention, hexavalent chromium is not detectable in the treated waste mixture. In addition, materials treated in accordance with the processes of the present invention contain reduced levels of total chromium (SPLP) in the treated mixture as compared to total chromium (SPLP) in the un-treated mixture. In one embodiment of the present invention, the treated mixture generally contains in the range of from about 0.1 to about 1 mg of total chromium (SPLP) per liter of treated waste mixture. In another embodiment of the present invention, the treated waste mixture contains less than about 0.6 mg/L of total chromium (SPLP).

Depending on the reagent employed, the pH of the treated materials may be reduced only slightly as compared to the pH of the un-treated materials. Generally, the pH of the treated materials is reduced by less than 2%. In one embodiment of the present invention, the pH of the treated material is in the range of from about 0.1 to about 1% less than the pH of the un-treated material. In another embodiment of the present invention, the pH of the treated material is in the range of from about 0.5 to about 1% less than the pH of the un-treated material.

The processes of this invention may be conducted in scaled up field operations/site remediation. The methodology and machinery may vary depending on the type of additive, soil condition, depth, etc. Those of skill in remediation of impacted soils and waste materials are familiar with the various types of machinery that may be used, including for example, pugmills, rotary augers, horizontal mixers and injection devices. For example, a caisson rig and 8′ diameter auger with a 60′ hollow Kelley bar may be used for the site remediation to aid in employing processes described herein.

For example, in site remediation, it is generally preferable to employ an excavator to locate and remove underground obstructions which would damage the equipment used in the operation. The excavator also may be used to turn over the soil and setting buried concrete, pipe sections, and other assorted debris to a designated staging area for size reduction and re-incorporation into the stabilized matrix.

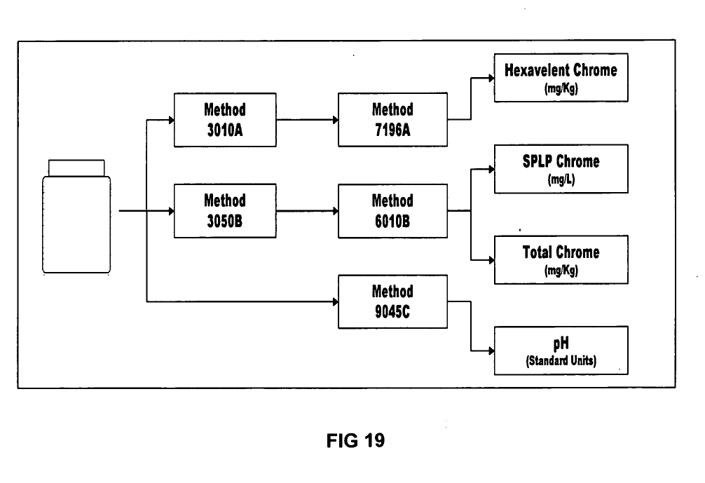

The excavating step is then generally followed by injection of the additive and optional hydraulic cement slurry into the soils/waste. Depending on the particular site, the processes of this invention may be implemented by first mixing the reagents in batch plants with recirculation (as needed) through frac tanks, and pumping through a Kelley bar and out to the auger head, as generally shown in the process diagram of FIG. 19.

The processes described herein allow for the un-treated waste materials to be contacted with the reagents in a single pass, thus avoiding multiple pass operations which are more costly. At the same time, the methods described herein achieve the desired objectives for treating impacted soils/waste in that Cr(VI) and SPLP Cr are at acceptable levels after treatment and are suitable to be left in place.

### EXAMPLES

The following examples are presented to further illustrate the present invention and are not to be construed as unduly limiting the scope of this invention.

### Example I

### Soil Sample Preparation

A total of nine (9) soil samples of solid waste obtained from a waste site were placed in 2-gallon high-density polyethylene (HDPE) containers. Each sample container included a bagged soil sample of approximately 12-15 lbs of material. The samples were labeled and assessed as shown in TABLE 1:

TABLE 1
Sample Data and Physical Properties

| | | | Estimated |
|---|---|---|---|
| | Indicated | | Moisture |
| Container | Depth | Physical Description | Content |
| 114-6A-4-S1 | 4–7 ft | Loose, non-homogenous, | 50% |
| | | Tan-Grey with some | |
| | | Green, Sandy Soil, some | |
| | | visible salts, free | |
| | | water. | |
| 114-6A-4-S2 | 7–10 ft | Loose, non-homogenous, | 40% |
| | | green-tan, soft, ore | |
| | | residues with trace | |
| | | sandy soil/rock, some | |
| | | visible salts. | |
| 114-6A-4-S3 | 10–13 ft | Loose, non-homogenous, | 35% |
| | | green-yellow, soft, ore | |
| | | residues with trace | |
| | | visible salts. | |
| 114-6A-4-S4 | 13–16 ft | Loose, non-homogenous, | 35% |
| | | green-yellow, soft, ore | |
| | | residues with trace | |
| | | sandy soil/rock, some | |
| | | visible salts. | |
| 114-F2-4-S1 | 4–7 ft | Loose, non-homogenous, | 30% |
| | | Dark Brown-Grey, sandy | |
| | | soil, some visible | |
| | | salts. | |
| 114-F2-4-S2 | 7–10 ft | Loose, non-homogenous, | 35% |
| | | brown-grey with trace | |
| | | green, sandy soil with | |
| | | trace ore, some visible | |
| | | salts. | |
| 114-F2-4-S3 | 10–13 ft | Loose, non-homogenous, | 35% |
| | | brown-grey with trace | |
| | | green, soft, well- | |
| | | graded, sandy soil with | |
| | | trace ore, some visible | |
| | | salts. | |
| 114-F2-4-S4 | 13–16 ft | Loose, non-homogenous, | 35% |
| | | brown-grey with trace | |
| | | green, soft, well- | |
| | | graded, sandy soil with | |
| | | trace ore, some visible | |
| | | salts. | |
| 114-F2-4-S5 | 16–19 ft | Loose, non-homogenous, | 35% |
| | | brown-orange, soft, | |
| | | well-graded, sandy | |
| | | soil. | |

The 114-6A (hereinafter referred to as “6A” or “highly contaminated samples”) samples represent a portion of the site materials that were expected to be nearly pure ore processing residues, with trace soil content and very high Cr(VI) concentrations. The 114-F2 samples (hereinafter referred to as the “F2” or “moderately contaminated samples”) represent the site materials expected to be more soil like, mixed or contaminated with ore processing residues and low to moderate Cr(VI) concentrations.

### Example II

### Analytical Methods

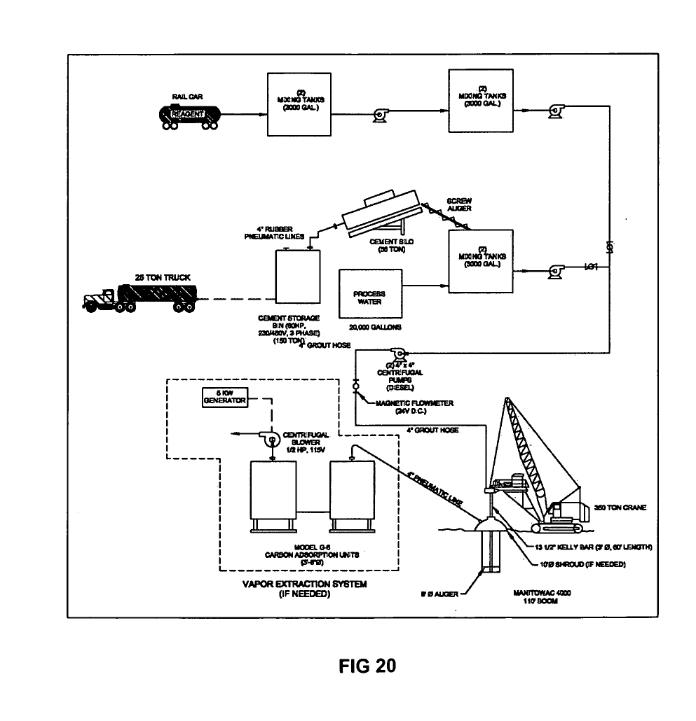

The samples identified in EXAMPLE I were analyzed to determine Total Chromium, Hexavalent Chromium (Cr(VI)), Total SPLP Chromium, and pH using the methods identified below. All samples were prepared, handled, and processed identically throughout the testing. The process is depicted in FIG. 20.

The analytical methods used are shown in TABLE II below:

TABLE 2
Analytical Methods

| Method | Description |
|---|---|
| SW-846-3010A | Acid Digestion |
| | Acid Digestion of Aqueous Samples and |
| | Extracts for Analysis by FLAA or ICP |
| | Spectroscopy. |
| SW-846-6010B | Chromium, SPLP (mg/L) |
| | Inductively Couple Plasma Atomic-Emission |
| | Spectrometry (ICP-AES) |
| SW-846-7196A | Hexavalent Chromium (mg/kg) |
| | Chromium, Hexavalent (Colorimetric) |
| SW-846-3050B | Acid Digestion |
| | Acid Digestion of Sediments, Sludges, and |
| | Solids |
| SW-846-6010B | Total Chromium (mg/kg) |
| | Inductively Couple Plasma Atomic-Emission |
| | Spectrometry (ICP-AES) |
| SW-846-9045C | pH (Standard Units) |
| | pH in Soils |

### Example III

### Untreated Sample Results

Each sample identified in EXAMPLE I was analyzed (using Method SW-846-7196A, colorimetric) to determine concentration of hexavalent chromium. The results of the analysis are provided in Table 3 below.

TABLE 3
Sample Hexavalent Chromium Data

| | | | | Average |
|---|---|---|---|---|
| | Triplicate Sample Cr(VI) | | | Cr(VI) |
| Sample | (mg/Kg) | | | (mg/Kg) |
| 114-6A-A-S1 A/B/C | 7,590 | 8,810 | 7,690 | 8,030 |
| 114-6A-A-S2 A/B/C | 10,200 | 11,700 | 9,560 | 10,487 |
| 114-6A-A-S3 A/B/C | 32,800 | 33,400 | 32,700 | 32,967 |
| 114-6A-A-S4 A/B/C | 43,200 | 44,400 | 46,600 | 44,733 |
| 114-F2-A-S1 A/B/C | 1,900 | 1,660 | 1,320 | 1,627 |
| 114-F2-A-S2 A/B/C | 4,050 | 3,370 | 3,380 | 3,600 |
| 114-F2-A-S3 A/B/C | 3,270 | 3,760 | 3,840 | 3,623 |
| 114-F2-A-S4 A/B/C | 4,420 | 5,050 | 4,790 | 4,753 |
| 114-F2-A-S5 A/B/C | 4,340 | 4,190 | 4,320 | 4,283 |

Two (2) of the nine (9) samples identified above were selected for use in the initial mix test (described further in EXAMPLE V below) as well as in the mix optimization test (described in EXAMPLE XII below). These samples, shown in Table 4 below possessed the highest level of Hexavalent Chromium concentration.

TABLE 4
Samples Chosen for Treatability Study

| | Average |
|---|---|
| | Cr(VI) |
| Sample | (mg/Kg) |
| 114-6A-4-S4 13′–16′ | 44,733 |
| 114-F2-4-S4 13′–16′ | 4,753 |

These materials were homogenized and sampled again prior to treatment to confirm the Chromium concentration and provide a baseline for evaluation. The selected samples were collected from the provided sample containers labeled 114-6A-4-S4, 13′-16′ and 114-F2-4-S4, 13′-16′. The results are shown in Tables 5 and 6 below:

TABLE 5
Untreated Results [Sample: 114-6A-4-S4, 13′–16′]

| | | | Untreated |
|---|---|---|---|
| | | | Sample |
| | | | Mix |
| | | Untreated Sample | Optimization |
| | | Initial Mix Test | Test |
| Parameter | Units | [EXAMPLE V] | [EXAMPLE XII] |
| pH | s.u. | 12.92 | 12.96 |
| Total Chrome | mg/Kg | 8,700 | 9,300 |
| Total Chrome SPLP | mg/L | 744 | 706 |
| Hexavalent Chrome | mg/kg | 31,600 | 33,800 |

TABLE 6
Untreated Results [Sample: 114-F2-4-S4, 13′–16′]

| | | Untreated Sample |
|---|---|---|
| Parameter | Units | Initial Mix Test |
| pH | s.u. | 13.08 |
| Total Chrome | mg/Kg | 175 |
| Total Chrome SPLP | mg/L | 22.3 |
| Hexavalent Chrome | mg/kg | 236 |

### Example IV

### Reagents

The following reagents were used in the treatability tests:

| Reagent | | Form |
|---|---|---|
| 1. | Ferrous Sulfate | Solid & Liquid |
| 2. | Sodium Metabisulfite | Solid & Liquid |
| 3. | Sodium Hydrosulfide | Solid & Liquid |
| 4. | Calcium Polysulfide | Liquid |
| 5. | Sodium/Calcium Polysulfide | Liquid |

Given the high oxidation number of hexavalent chromium, and drawing from previous experience, the inventors evaluated various reagents in an attempt to precipitate chromium hydroxide.

Below is a simplified chemical equation showing the precipitation of chromium hydroxide using calcium polysulfide as reagent.

Step 1: Calcium polysulfide in the solution reacts with water to form calcium hydroxide.

2 CaS+2H₂O->Ca (HS)₂+Ca(OH)₂

Step 2: Then the hydroxide ion from the calcium hydroxide reacts with the Cr 6+ to precipitate chromium hydroxide.

Cr6++3OH—->Cr(OH)₃

### Example V

### Initial Mix Test Sample Preparation and Reagent Addition

The purpose of the initial mix testing was to establish the efficacy and range of reagent addition in treating the material to the specified UTS. A range of reagent addition (2.5%-15%) was tested to establish baseline data for the appropriate selection of reagent. The initial mix testing used all reagents identified in EXAMPLE IV, as solids or in solution, on both a highly contaminated and moderately contaminated sample from the site.

Blending and Homogenization. The field samples identified in EXAMPLE I were initially mixed and turned to ensure consistency throughout the material. The material was removed from the container, placed in a mixing bowl, and mixed to break existing cohesion and distribute the material evenly. From the homogenized material, 100 g aliquots of material were prepared for each initial reagent mix test in aluminum pans.

Reagent Preparation and Addition. The reagents identified in EXAMPLE IV were then prepared and placed in aluminum pans. Solid reagents were prepared by measuring the reagent on a weight to weight ratio. For example, if a 5.0% reagent addition was tested, then 5.0 g of solid reagent was measured and added to the 100 g soil aliquot. Similarly, if a 10% reagent addition was tested, then 10.0 g of solid reagent was measured and added to the 100 g soil aliquot.

Liquid reagents were prepared in two (2) pans, reagent and water, and mixed prior to addition. The reagents were added shortly after mixing was initiated to simulate the startup of potential field slurry addition systems with the mixing process.

Mixing Apparatus. A Kitchen Aid 5-quart stand mixer with flat-beater attachment was used to simulate the mixing effort of a caisson-drill in the field. The COPR material was added to the mixing bowl, and the mixer was started. After the mixer was fully engaged, the reagent was added to the soils.

Sample Preparation, Preservation, Shipping & Analysis. The entire mixed sample in the Kitchen Aid mixing bowl was directly transferred to a 500 oz sample jar. The jars were not immediately sealed to simulate the field exposure of the material after mixing as the caisson-drill would move from location to location. This duration was generally 10-15 minutes. The jars were sealed with no preservative, appropriately labeled, and placed in the shipping cooler. The cooler was prepared with ice to maintain 4° C., and the samples were transported to the laboratory the next morning by laboratory courier.

### Example VI

### Initial Mix Test Analysis and Results

The treated samples were analyzed to determine Total Chromium, Hexavalent Chromium (Cr(VI)), Total SPLP Chromium, and Soil pH using the methods identified in EXAMPLE II. All samples were prepared, handled, and processed identically throughout the testing.

The results of the Initial Mix Test are presented in Tables and Figures in the specific examples below (based on the reagent tested), and are summarized in the following tables:

| | |
|---|---|
| Highly Contaminated | |
| Sample: | |
| 114-6A-4-S4, 13′–16′ | Analytical |

| | |
|---|---|
| Addition | Results |

| EXAMPLE | Reagent | Method | Table | FIG. |
|---|---|---|---|---|
| VII | Ferrous | Solid | 7-A1 | 1 |
| | Sulfate | | | |
| VII | Ferrous | Solution | 7-A2 | 2 |
| | Sulfate | | | |
| VIII | Sodium | Solid | 8-A1 | 5 |
| | MetaBiSulfite | | | |
| VIII | Sodium | Solution | 8-A2 | 6 |
| | MetaBiSulfite | | | |

| | |
|---|---|
| Highly Contaminated | |
| Sample: | Analytical |
| 114-6A-4-S4, 13′–16′ | Results |

| | | | | |
|---|---|---|---|---|
| IX | Sodium | Solid | 9-A1 | 9 |
| | HydroSulfite | | | |
| IX | Sodium | Solution | 9-A2 | 10 |
| | HydroSulfite | | | |
| X | Calcium | Solution | 10-A1 | 13 |
| | Polysulfide | | | |
| XI | Sodium/Calcium | Solution | 11-A1 | 15 |
| | Polysulfide | | | |

| | |
|---|---|
| Moderately Contaminated | |
| Sample: 114-F2-4-S4, 13′–16′ | Analytical |

| | |
|---|---|
| Addition | Results |

| EXAMPLE | Reagent | Method | Table | FIG. |
|---|---|---|---|---|
| VII | Ferrous | Solid | 7-B1 | 3 |
| | Sulfate | | | |
| VII | Ferrous | Solution | 7-B2 | 4 |
| | Sulfate | | | |
| VIII | Sodium | Solid | 8-B1 | 7 |
| | MetaBiSulfite | | | |
| VIII | Sodium | Solution | 8-B2 | 8 |
| | MetaBiSulfite | | | |
| IX | Sodium | Solid | 9-B1 | 11 |
| | HydroSulfite | | | |
| IX | Sodium | Solution | 9-B2 | 12 |
| | HydroSulfite | | | |
| X | Calcium | Solution | 10-B1 | 14 |
| | Polysulfide | | | |
| XI | Sodium/Calcium | Solution | 11-B1 | 16 |
| | Polysulfide | | | |

The untreated sample results described in EXAMPLE III above are provided in each of the tables below for comparison purposes.

### Example VII

### Ferrous Sulfate

### A. Highly Contaminated Sample: 114-6A-4-S4, 13′-16′

TABLE 7-A1
FERROUS SULFATE (FeSO₄) added as a Solid

| | | Reagent Addition Rates, wt/wt | | | | | |
|---|---|---|---|---|---|---|---|
| | | | 5% | 7.5% | 10% | 12.5% | 15% |
| Parameter | Units | Untreated | FeSO₄ | FeSO₄ | FeSO₄ | FeSO₄ | FeSO₄ |
| pH | s.u. | 12.92 | 12.72 | 12.61 | 12.41 | 12.19 | 11.99 |
| Total | mg/L | 744 | 487 | 422 | 328 | 456 | 355 |
| Chrome | | | | | | | |
| SPLP | | | | | | | |
| Hexavalent | mg/kg | 31,600 | 4,200 | 2,460 | 3,200 | 3,290 | 3,250 |
| Chrome | | | | | | | |

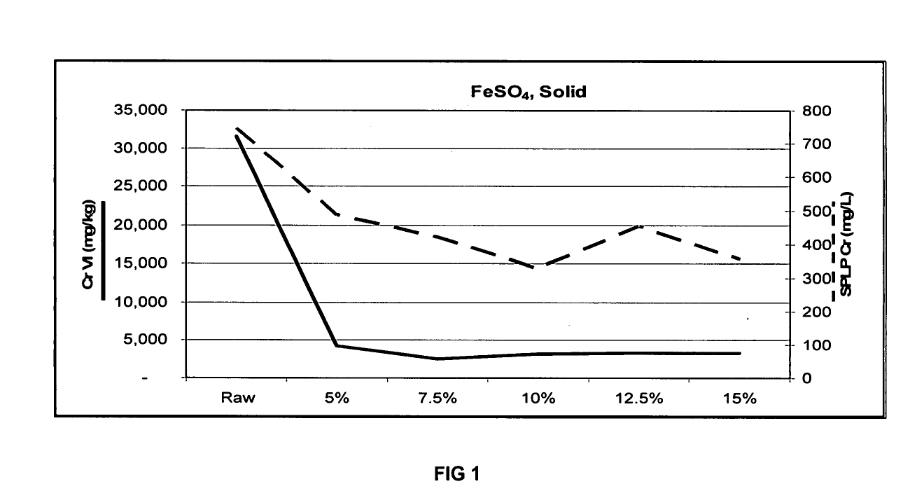

The results in Table 7-A1 are shown in FIG. 1.

TABLE 7-A2
FERROUS SULFATE (FeSO₄) added in Solution
(1 part reagent/2 parts water)

| | | Reagent Addition Rates, wt/wt | | | | | | |
|---|---|---|---|---|---|---|---|---|
| | | | 2.5% | 5% | 7.5% | 10% | 12.5% | 15% |
| Parameter | Units | Untreated | FeSO₄ | FeSO₄ | FeSO₄ | FeSO₄ | FeSO₄ | FeSO₄ |
| pH | s.u. | 12.92 | 12.79 | 12.80 | 12.88 | 12.59 | 12.41 | 11.91 |
| Total | mg/L | 744 | 606 | 426 | 299 | 256 | 180 | 165 |
| Chrome | | | | | | | | |
| SPLP | | | | | | | | |
| Hexavalent | mg/kg | 31,600 | 4,640 | 4,750 | 3,630 | 1,900 | 1,870 | 1,510 |
| Chrome | | | | | | | | |

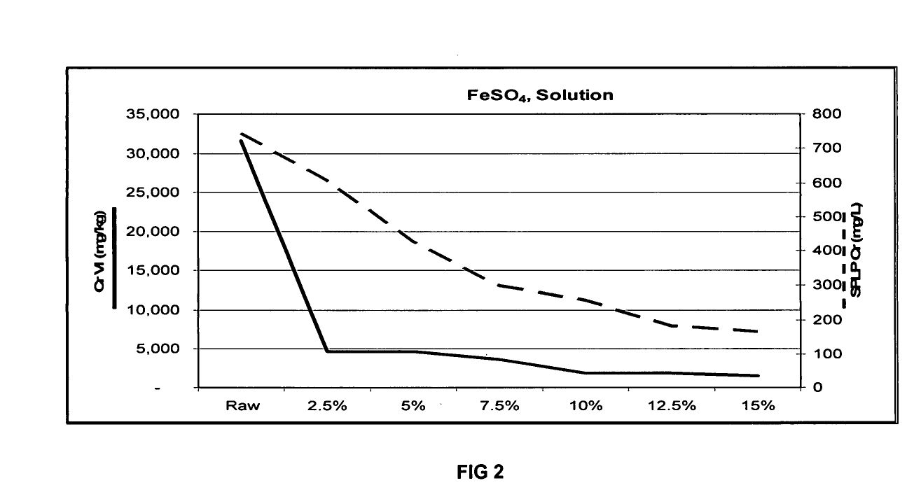

The results in Table 7-A2 are shown in FIG. 2.

### B. Moderately Contaminated Sample: 114-F2-4-S4, 13′-16′

TABLE 7-B1
FERROUS SULFATE (FeSO₄) added as a solid

| | | Reagent Addition Rates, wt/wt | | | | |
|---|---|---|---|---|---|---|
| | | | 3% | 5% | 7.5% | 10% |
| Parameter | Units | Untreated | FeSO₄ | FeSO₄ | FeSO₄ | FeSO₄ |
| Ph | s.u. | 13.08 | 13.03 | 12.95 | 12.87 | 12.84 |
| Total | mg/L | 22.3 | 9.78 | 7.61 | 7.04 | 1.94 |
| Chrome | | | | | | |
| SPLP | | | | | | |
| Hexavalent | mg/kg | 236 | 100 | 102 | 66 | 42 |
| Chrome | | | | | | |

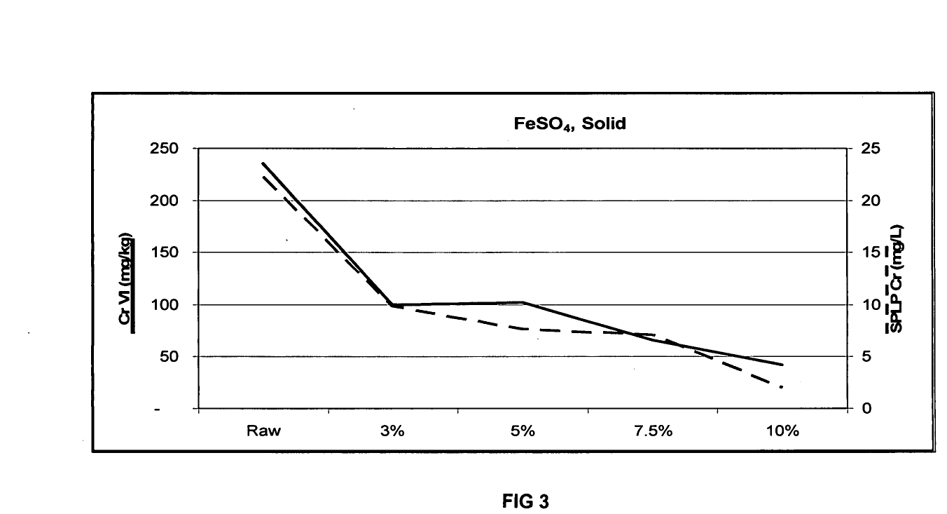

The results in Table 7-B1 are shown in FIG. 3.

TABLE 7-B2
FERROUS SULFATE (FeSO₄) added in Solution (1 part
reagent/2 parts water)

| | | Reagent Addition Rates, wt/wt | | | | |
|---|---|---|---|---|---|---|
| | | | 2.5% | 5% | 7.5% | 10% |
| Parameter | Units | Untreated | FeSO₄ | FeSO₄ | FeSO₄ | FeSO₄ |
| pH | s.u. | 13.08 | 13.18 | 13.02 | 12.97 | 12.90 |
| Total | mg/L | 22.3 | 10.3 | 4.13 | 0.857 | 0.150 |
| Chrome | | | | | | |
| SPLP | | | | | | |
| Hexavalent | mg/kg | 236 | 103 | 35.1 | 10.2 | 0.900 |
| Chrome | | | | | | |

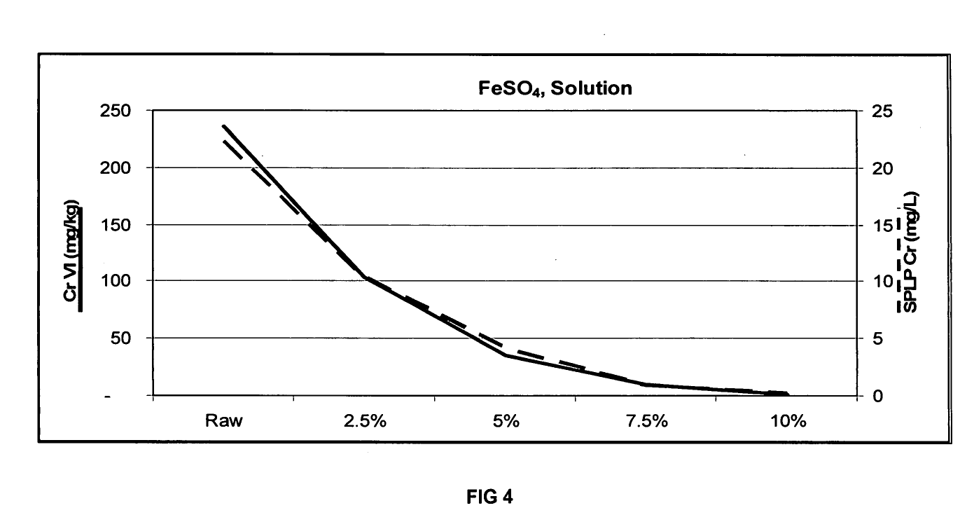

The results in Table 7-B2 are shown in FIG. 4.

### Example VIII

### Sodium Metabisulfite

### A. Highly Contaminated Sample: 114-6A-4-S4, 13′-16′

TABLE 8-A1
SODIUM METABISULFITE (Na₂S₂O₅, Sodium PyroSulfite)
added as a Solid

| | | Reagent Addition Rates, wt/wt | | | | | |
|---|---|---|---|---|---|---|---|
| | | | 5% | 7.5% | 10% | 12.5% | 15% |
| Parameter | Units | Untreated | Na₂S₂O₅ | Na₂S₂O₅ | Na₂S₂O₅ | Na₂S₂O₅ | Na₂S₂O₅ |
| pH | s.u. | 12.92 | 12.98 | 12.97 | 13.00 | 12.89 | 12.75 |
| Total | mg/L | 744 | 530 | 392 | 414 | 400 | 410 |
| Chrome | | | | | | | |
| SPLP | | | | | | | |
| Hexavalent | mg/kg | 31,600 | 5,800 | 6,600 | 4,260 | 7,400 | 5,400 |
| Chrome | | | | | | | |

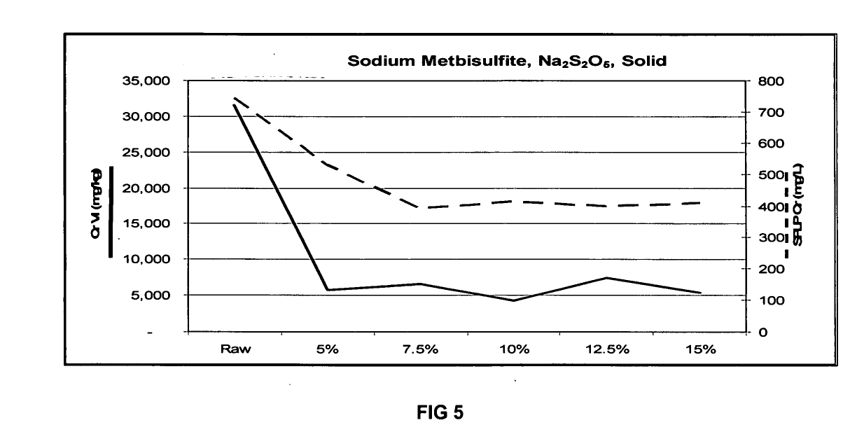

The results in Table 8-A1 are shown in FIG. 5.

TABLE 8-A2
Sodium Meta Bisulfite (Na₂S₂O₅, Sodium PyroSulfite)
added in Solution (1 part reagent/2 part water)

| | | Reagent Addition Rates, wt/wt | | | | | | |
|---|---|---|---|---|---|---|---|---|
| | | | 2.5% | 5% | 7.5% | 10% | 12.5% | 15% |
| Parameter | Units | Untreated | Na₂S₂O₅ | Na₂S₂O₅ | Na₂S₂O₅ | Na₂S₂O₅ | Na₂S₂O₅ | Na₂S₂O₅ |
| Ph | s.u. | 12.92 | 12.92 | 12.85 | 12.95 | 13.01 | 12.94 | 12.59 |
| Total | Mg/L | 744 | 455 | 666 | 502 | 173 | 303 | 138 |
| Chrome | | | | | | | | |
| SPLP | | | | | | | | |
| Hexavalent | Mg/kg | 31,600 | 4,900 | 2,440 | 4,790 | 4,620 | 4,880 | 3,380 |
| Chrome | | | | | | | | |

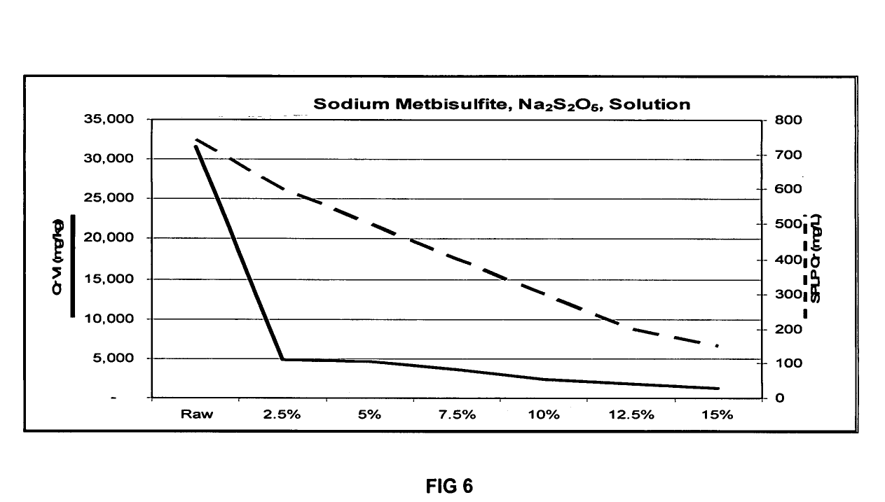

The results in Table 8-A2 are shown in FIG. 6.

### B. Moderately Contaminated Sample: 114-F2-4-S4, 13′-16′

TABLE 8-B1
SODIUM METABISULFITE (Na₂S₂O₅, Sodium PyroSulfite)
added as a solid

| | | Reagent Addition Rates, wt/wt | | | | |
|---|---|---|---|---|---|---|
| | | | 3% | 5% | 7.5% | |
| Parameter | Units | Untreated | Na₂S₂O₅ | Na₂S₂O₅ | Na₂S₂O₅ | 10% Na₂S₂O₅ |
| pH | s.u. | 13.08 | 13.27 | 13.31 | 13.28 | 13.49 |
| Total | mg/L | 22.3 | 25.7 | 31.8 | 37.7 | 34.6 |
| Chrome | | | | | | |
| SPLP | | | | | | |
| Hexavalent | mg/kg | 236 | 413 | 430 | 450 | 359 |
| Chrome | | | | | | |

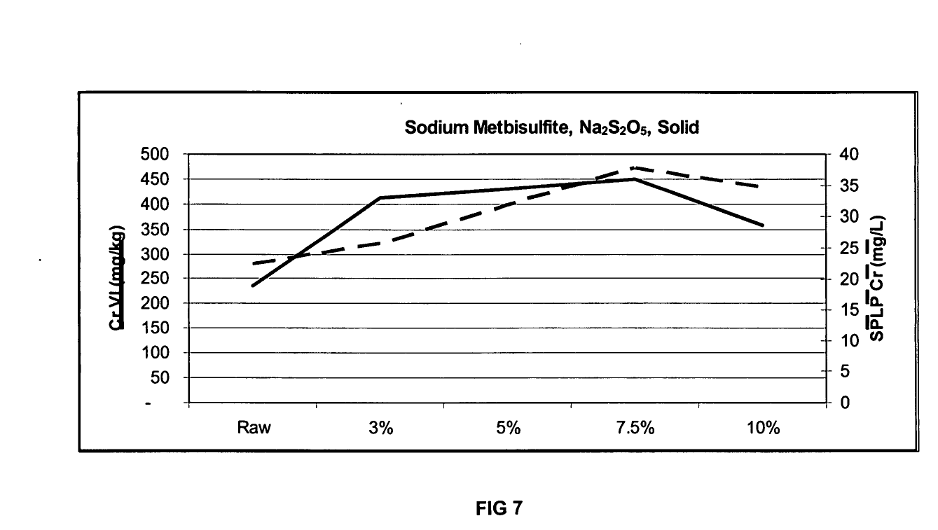

The results in Table 8-B1 are shown in FIG. 7.

TABLE 8-B2
Sodium Meta Bisulfite (Na₂S₂O₅, Sodium PyroSulfite)
added in Solution (1 part reagent/2 parts water)

Reagent Addition Rates, wt/wt

| | | | 2.5% | 5% | 7.5% | |
|---|---|---|---|---|---|---|
| Parameter | Units | Untreated | Na₂S₂O₅ | Na₂S₂O₅ | Na₂S₂O₅ | 10% Na₂S₂O₅ |
| pH | s.u. | 13.08 | 13.25 | 13.30 | 13.33 | 13.36 |
| Total | mg/L | 22.3 | 34.3 | 27 | 31.3 | 27.2 |
| Chrome SPLP | | | | | | |
| Hexavalent | mg/kg | 236 | 325 | 302 | 228 | 183 |
| Chrome | | | | | | |

The results in Table 8-B2 are shown in FIGURE b.

### Example IX

### Sodium Hydrosulfite

### A. Highly Contaminated Sample: 114-6A-4-S4, 13′-16′

TABLE 9-A1
SODIUM HYDROSULFITE (Na₂S₂O₄, Sodium Dithionite)
added as a Solid

| | | Reagent Addition Rates, wt/wt | | | | | |
|---|---|---|---|---|---|---|---|
| | | | 5% | 7.5% | 10% | 12.5% | 15% |
| Parameter | Units | Untreated | Na₂S₂O₄ | Na₂S₂O₄ | Na₂S₂O₄ | Na₂S₂O₄ | Na₂S₂O₄ |
| pH | s.u. | 12.92 | 13.11 | 12.90 | 12.87 | 12.95 | 12.95 |
| Total | mg/L | 744 | 319 | 342 | 264 | 221 | 207 |
| Chrome | | | | | | | |
| SPLP | | | | | | | |
| Hexavalent | mg/kg | 31,600 | 3,050 | 2,480 | 1,910 | 1,900 | 1,350 |
| Chrome | | | | | | | |

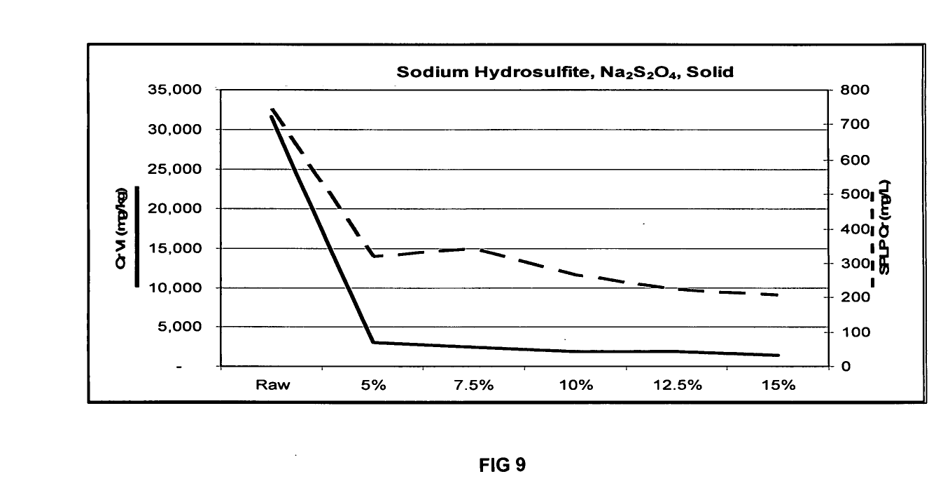

The results in Table 9-A1 are shown in FIG. 9.

TABLE 9-A2
(Na₂S₂O₄, Sodium Dithionite) added in Solution (1
part reagent/2 parts water)

| | | Reagent Addition Rates, wt/wt | | | | | | |
|---|---|---|---|---|---|---|---|---|
| | | | 2.5% | 5% | 7.5% | 10% | 12.5% | 15% |
| Parameter | Units | Untreated | Na₂S₂O₄ | Na₂S₂O₄ | Na₂S₂O₄ | Na₂S₂O₄ | Na₂S₂O₄ | Na₂S₂O₄ |
| pH | s.u. | 12.92 | 13.07 | 13.27 | 13.33 | 13.31 | 13.32 | 13.18 |
| Total | mg/L | 744 | 357 | 162 | 89.4 | 79.7 | 59.4 | 44.7 |
| Chrome | | | | | | | | |
| SPLP | | | | | | | | |
| Hexavalent | mg/kg | 31,600 | 4,790 | 2,150 | 730 | 710 | 122 | 46 |
| Chrome | | | | | | | | |

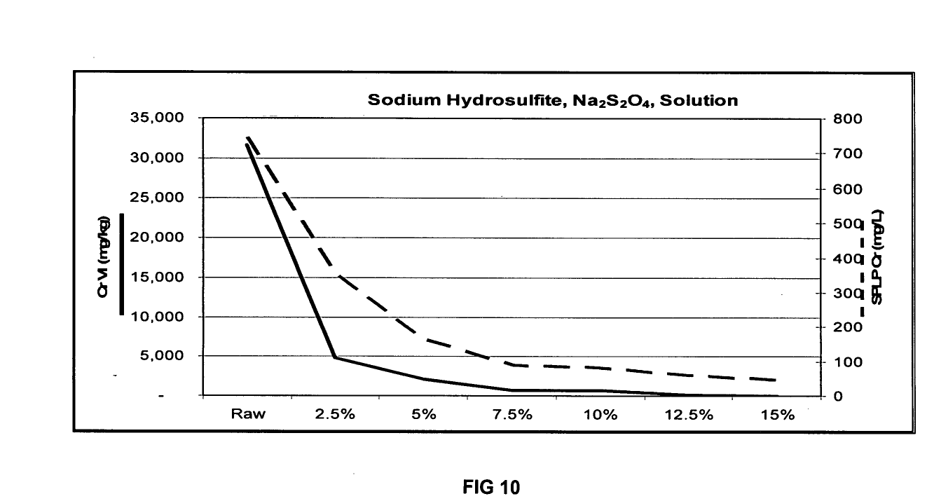

The results in Table 9-A2 are shown in FIG. 10.

### B. Moderately Contaminated Sample: 114-F2-4-S4, 13′-16′

TABLE 9-B1
SODIUM HYDROSULFITE (Na₂S₂O₄, Sodium Dithionite) added
as a solid

| | | Reagent Addition Rates, wt/wt | | | | |
|---|---|---|---|---|---|---|
| | | | 3% | 5% | 7.5% | |
| Parameter | Units | Untreated | Na₂S₂O₄ | Na₂S₂O₄ | Na₂S₂O₄ | 10% Na₂S₂O₄ |
| pH | s.u. | 13.08 | 13.26 | 13.25 | 13.30 | 13.33 |
| Total | mg/L | 22.3 | 15.1 | 19.5 | 23.2 | 19 |
| Chrome | | | | | | |
| SPLP | | | | | | |
| Hexavalent | mg/kg | 236 | 121 | 144 | 99 | 1.9 |
| Chrome | | | | | | |

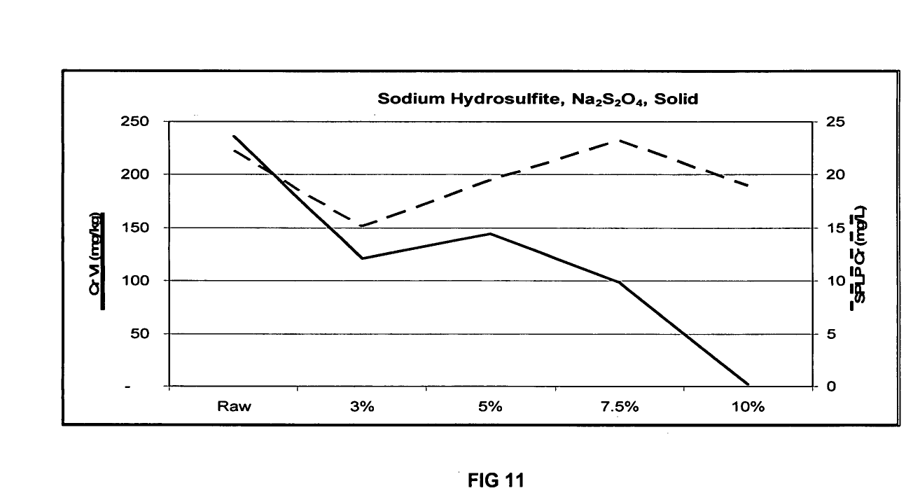

The results in, Table 9-B1 are shown in FIG. 11.

TABLE 9-B2
Sodium Hydrosulfite (Na₂S₂O₄, Sodium Dithionite)
added in Solution (1 part reagent/2 parts water)

| | | Reagent Addition Rates, wt/wt | | | | |
|---|---|---|---|---|---|---|
| | | | 2.5% | 5% | 7.5% | |
| Parameter | Units | Untreated | Na₂S₂O₄ | Na₂S₂O₄ | Na₂S₂O₄ | 10% Na₂S₂O₄ |
| pH | s.u. | 13.08 | 13.33 | 13.30 | 13.33 | 13.34 |
| Total | mg/L | 22.3 | 5.7 | 8.77 | 8.51 | 8.45 |
| Chrome | | | | | | |
| SPLP | | | | | | |
| Hexavalent | Mg/kg | 236 | 59 | 2.9 | <0.1 | <0.1 |
| Chrome | | | | | | |

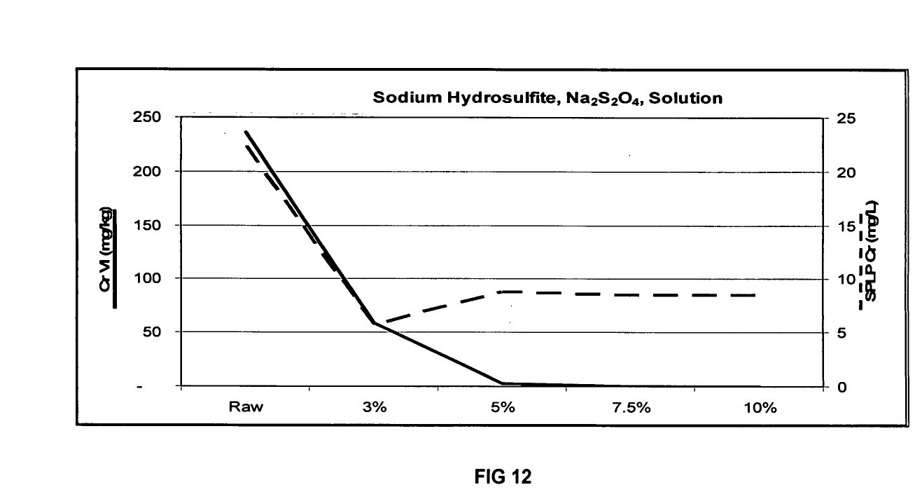

The results in Table 9-B2 are shown in FIG. 12.

### Example X

### Calcium Polysulfide

### A. Highly Contaminated Sample: 114-6A-4-S4, 13′-16′

TABLE 10-A1
CALCIUM POLYSULFIDE (CaSₓ, Aqua-Clear) solution, by
VGS, Inc.

| | | Reagent Addition Rates, wt/wt | | | | |
|---|---|---|---|---|---|---|
| | | | 10% | 15% | 20% | |
| Parameter | Units | Untreated | Na/CaSₓ | Na/CaSₓ | Na/CaSₓ | 25% Na/CaSₓ |
| pH | s.u. | 12.92 | 13.04 | 13.12 | 13.14 | 13.17 |
| Total | mg/L | 744 | 298 | 166 | 103 | 85 |
| Chrome SPLP | | | | | | |
| Hexavalent | mg/kg | 31,600 | 4,880 | 2,680 | 1,530 | 790 |
| Chrome | | | | | | |

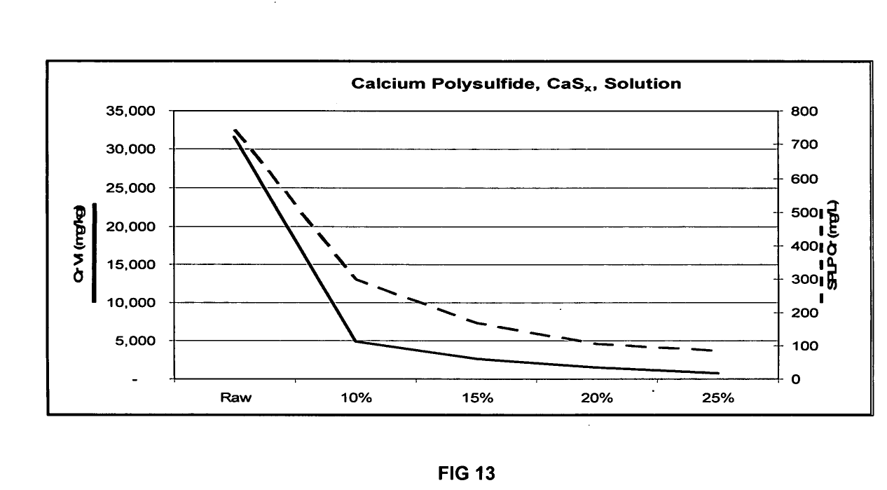

The results in Table 10-A1 are shown in FIG. 13.

### B. Moderately Contaminated Sample: 114-F2-4-S4, 13′-16′

TABLE 10-B1
CALCIUM POLYSULFIDE (CaSₓ, Aqua-Clear) solution, by
VGS, Inc.

| | | Reagent Addition Rates, wt/wt | | | | |
|---|---|---|---|---|---|---|
| | | | 5% | 7.5% | 10% | |
| Parameter | Units | Untreated | Na/CaSₓ | Na/CaSₓ | Na/CaSₓ | 12.5% Na/CaSₓ |
| pH | s.u. | 12.92 | 12.87 | 12.80 | 12.56 | 12.53 |
| Total | mg/L | 22.3 | 12.6 | 11.6 | 12.8 | 7.2 |
| Chrome | | | | | | |
| SPLP | | | | | | |
| Hexavalent | mg/kg | 236 | 62 | 8.3 | 3 | 1.5 |
| Chrome | | | | | | |

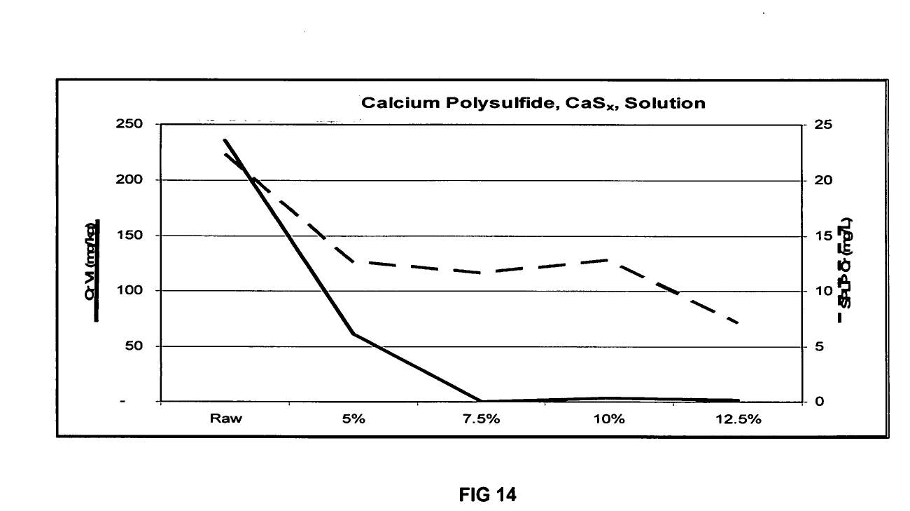

The results in Table 10-B1 are shown in FIG. 14.

### Example XI

### Sodium/Calcium Polysulfide

### A. Highly Contaminated Sample: 114-6A-4-S4, 13′-16′

TABLE 11-A1
SODIUM/CALCIUM POLYSULFIDE (Na/CaSₓ) solution, Redox
Solutions, LLC.

| | | Reagent Addition Rates, wt/wt | | | | |
|---|---|---|---|---|---|---|
| | | | 10% | 15% | 20% | |
| Parameter | Units | Untreated | Na/CaSₓ | Na/CaSₓ | Na/CaSₓ | 25% Na/CaSₓ |
| pH | s.u. | 13.08 | 13.07 | 13.12 | 13.09 | 12.99 |
| Total | mg/L | 744 | 130 | 54 | 3.23 | 1.13 |
| Chrome | | | | | | |
| SPLP | | | | | | |
| Hexavalent | mg/kg | 31,600 | 1,230 | 330 | ND | 220 |
| Chrome | | | | | | |

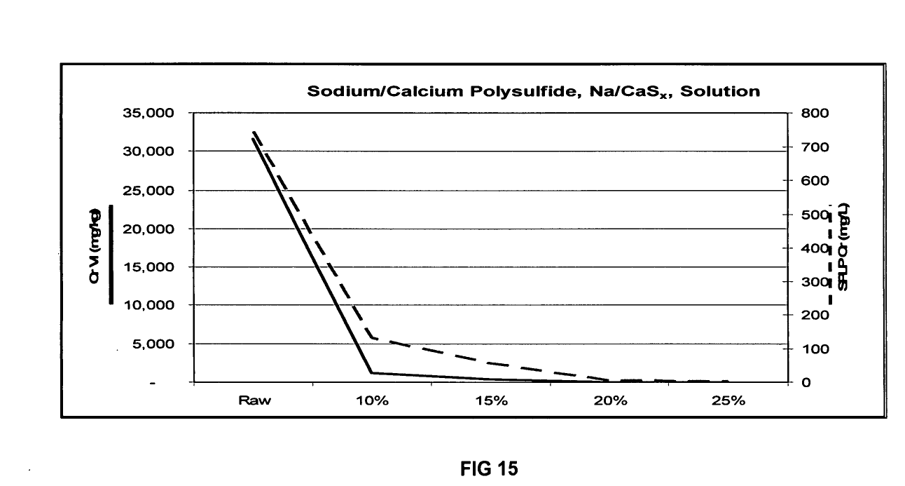

The results in Table 11-A1 are shown in FIG. 15.

### B. Moderately Contaminated Sample: 114-F2-4-S4, 13′-16′

TABLE 11-B1
SODIUM/CALCIUM POLYSULFIDE (Na/CaSₓ) solution, Redox
Solutions, LLC

| | | Reagent Addition Rates, wt/wt | | | | |
|---|---|---|---|---|---|---|
| | | | 5% | 7.5% | 10% | |
| Parameter | Units | Untreated | Na/CaSₓ | Na/CaSₓ | Na/CaSₓ | 12.5% Na/CaSₓ |
| pH | s.u. | 13.08 | 12.90 | 12.77 | 12.70 | 12.61 |
| Total | mg/L | 22.3 | 12.1 | 13.7 | 0.3 | 0.16 |
| Chrome | | | | | | |
| SPLP | | | | | | |
| Hexavalent | mg/kg | 236 | 18 | 14 | 65 | 141 |
| Chrome | | | | | | |

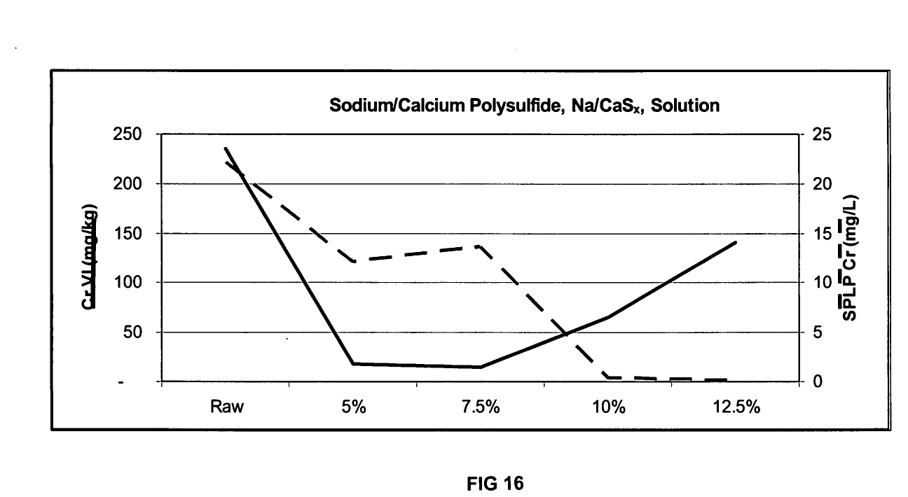

The results in Table 11-B1 are shown in FIG. 16.

### Example XII

### Mix Optimization Test

In this Mix Optimization Test, the Sodium/Calcium Polysulfide was re-mixed to confirm the addition rate at which ND was reached for Cr(VI). Additionally, the addition of Portland cement was examined to render the SPLP Total Chrome within the desired target of <0.6 mg/L.

In the Initial Mix Test described in EXAMPLES V and VI, sodium/calcium polysulfide was capable of reducing the Cr(VI) to ND at a reasonable addition rate. However, although Cr(VI) was driven to ND, the SPLP Total Chrome value, consisting primarily of CrIII, was still present above the 0.6 mg/L target. In this example, the performance of Sodium/Calcium Polysulfide (Coprex) was confirmed; and the addition rate of Portland cement was evaluated to address the leachable Total Chrome result. The Portland cement was added to the mixed material after the addition of the reagent. Only the highly contaminated sample was considered for the Mix Optimization Testing.

The highly contaminated treated sample was analyzed to determine Total Chromium, Hexavalent Chromium (Cr(VI)), Total SPLP Chromium, and Soil pH using the methods identified in EXAMPLE II. All samples were prepared, handled, and processed identically throughout the testing.

The results of the Mix Optimization Test are summarized in Table 12 below and in the following EXAMPLE XIII.

TABLE 12
MIX OPTIMIZATION TEST SUMMARY

| | |
|---|---|
| Highly Contaminated: | |
| 114-6A-4-S4, 13′–16′ | Analytical |

| | |
|---|---|
| Addition | Results |

| Reagent | Method | Table | FIG. |
|---|---|---|---|
| Sodium/Calcium | Solution | 13-A1 | 17 |
| Polysulfide | | | |
| Sodium/Calcium | Solution, | 13-B1 | 18 |
| Polysulfide with | Slurry | | |
| Portland cement | | | |

### Example XIII

### Mix Optimization Test Results

### Sodium/Calcium Polysulfide

### A. Highly Contaminated Sample (without Portland Cement): 114-6A-4-S4, 13′-16′

TABLE 13-A1
SODIUM/CALCIUM POLYSULFIDE (Na/CaSₓ) solution, Redox
Solutions, LLC.

| | | Reagent Addition Rates, wt/wt | | |
|---|---|---|---|---|
| | | | 17.5% | |
| Parameter | Units | Untreated | Na/CaSₓ | 20% Na/CaSₓ |
| pH | s.u. | 12.96 | 12.77 | 12.7 |
| Total Chrome SPLP | mg/L | 706 | 1.04 | 0.189 |
| Hexavalent Chrome | mg/kg | 33,800 | ND | ND |

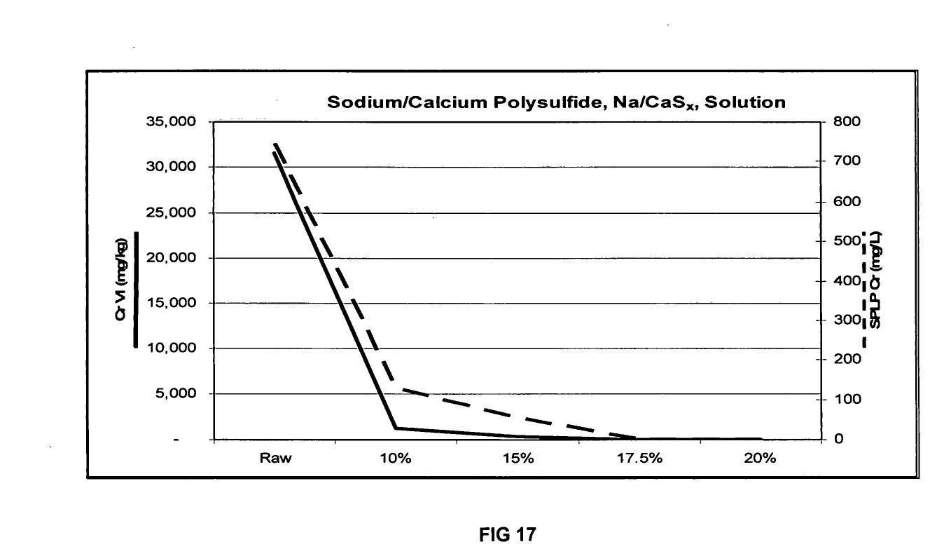

The results in Table 13-A1 are shown in FIG. 17.

### B. Highly Contaminated Sample (with Portland Cement): 114-6A-4-S4, 13′-16′

TABLE 13-B1
SODIUM/CALCIUM POLYSULFIDE (Na/CaSₓ) solution, by
Redox Solutions, LLC, with Portland Cement Type II solution (1
part PC/0.75 parts water)

| | | Reagent Addition Rates, wt/wt | | | |
|---|---|---|---|---|---|
| | | | 20% | 20% | 20% |
| | | | Na/CaSₓ | Na/CaSₓ | Na/CaSₓ |
| | | | 10% | 15% | 20% |
| | | | Portland | Portland | Portland |
| Parameter | Units | Untreated | Type II | Type II | Type II |
| pH | s.u. | 12.96 | 12.67 | 12.75 | 12.77 |
| Total Chrome | mg/L | 706 | 1.69 | 0.432 | 0.865 |
| SPLP | | | | | |
| Hexavalent | mg/kg | 33,800 | ND | ND | ND |
| Chrome | | | | | |

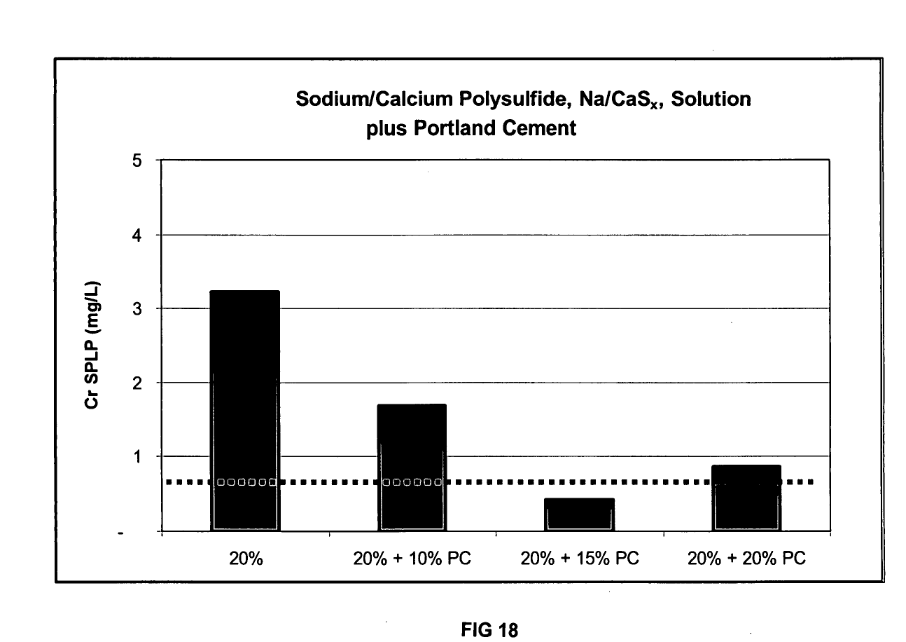

The results in Table 13-B1 are shown in FIG. 18.

As shown above, the addition of the Sodium/Calcium Polysulfide (Coprex) reagent at 17.5%-20% by weight, followed by a 15% addition of Portland cement, brought the Cr(VI) to Non Detect, and remaining leachable Cr III at acceptable levels.

Although certain preferred embodiments of the invention have been described in detail, those skilled in the art will recognize that various substitutions for, and modifications of, these embodiments, may be made without departing from the spirit and scope of the invention as defined solely by the appended claims.

What is claimed is:

1. A process for stabilizing and treating solid wastes containing hexavalent chromium comprising:
mixing a solid waste material containing hexavalent chromium to produce an untreated waste mixture;
contacting the untreated waste mixture with sodium/calcium polysulfide to produce a treated waste mixture,
wherein the treated waste mixture contains less hexavalent chromium than the untreated waste mixture.

2. The process of claim 1, wherein the process is conducted in a single pass.

3. The process of claim 1, wherein the process is conducted in-situ.

4. The process of claim 1, wherein the sodium/calcium polysulfide is contacted with the untreated waste mixture at an addition rate in the range of from about 17 weight percent to about 20 weight percent, based on the weight of the untreated waste mixture.

5. The process of claim 1, wherein hexavalent chromium is reduced to trivalent chromium.

6. The process of claim 1, wherein the treated mixture contains in the range of from about 0.1 to about 1 mg of total chromium (SPLP) per liter of treated waste mixture.

7. The process of claim 1, wherein no hexavalent chromium is detectable in the treated waste mixture.

8. The process of claim 1, wherein the pH of the treated waste mixture is less than the pH of the untreated waste mixture.

9. The process of claim 1, wherein the pH of the treated waste mixture is about 1% less than the pH of the untreated waste mixture.

10. The process of claim 1, wherein the process does not require an initial pre-treatment step to adjust the pH of the untreated waste mixture.

11. The process of claim 1, further comprising contacting the treated waste mixture with a hydraulic cement.

12. The process of claim 11, wherein the hydraulic cement is Portland cement.

13. The process of claim 12, wherein the Portland Cement is Type II Portland Cement and is added in solution at a rate in the range of from about 15% to about 20% by weight, based on the weight of the untreated waste mixture.

14. The process of claim 1, wherein the untreated mixture is contacted with a slurry of sodium/calcium polysulfide and a hydraulic cement.

15. The process of claim 1, wherein the untreated mixture is contacted with a slurry of sodium/calcium polysulfide and Type II Portland cement.

16. The process of claim 1, wherein the treated waste mixture contains less than about 0.6 mg/L of total chromium (SPLP).

17. A process for stabilizing and treating solid wastes containing hexavalent chromium comprising:
contacting an untreated waste mixture with a slurry of sodium/calcium polysulfide and hydraulic cement to produce a treated waste mixture, wherein hexavalent chromium is not detectable in the treated waste mixture and wherein the treated waste mixture contains less than about 0.6 mg/L of total chromium (SPLP).

18. The process of claim 17, wherein the process is conducted in a single pass.

19. The process of claim 17, wherein the process is conducted in-situ.

20. The process of claim 17, wherein sodium/calcium polysulfide is contacted with the untreated waste mixture at an addition rate in the range of from about 17.5 weight percent to about 20 weight percent, based on the weight of the untreated waste mixture.

21. The process of claim 17, wherein sodium/calcium polysulfide is contacted with the untreated waste mixture at an addition rate of about 20 weight percent, based on the weight of the untreated waste mixture.

22. The process of claim 17, wherein hexavalent chromium is reduced to trivalent chromium.

23. The process of claim 17, wherein the pH of the treated mixture is less than the pH of the untreated waste mixture.

24. The process of claim 17, wherein the pH of the treated waste mixture is about 1% less than the pH of the untreated waste mixture.

25. A process for treating/reducing hexavalent chromium in impacted soils comprising contacting solid wastes containing hexavalent chromium with sodium/calcium polysulfide at an addition rate in the range of from about 17.5 to about 20% weight percent based on the weight of the solid waste, followed by subsequent treatment of 15% by weight Portland cement.

26. A composition comprising soil, chromium, sodium/calcium polysulfide and Portland cement, produced by the process of:
mixing a solid waste material containing hexavalent chromium to produce an untreated waste mixture;
contacting the untreated waste mixture with sodium/calcium polysulfide and Portland cement under reaction conditions to produce a treated waste mixture, wherein the treated waste mixture contains no detectable levels of hexavalent chromium and less than about 0.6 mg/L total chromium (SPLP).
